(19) United States
(12) Patent Application Publication
(10) Pub. No.: US 2013/0055575 A1
(43) Pub. Date: Mar. 7, 2013

(54) DEVICE FOR CONTROLLING THE RELATIVE POSITIONING OF TWO ELEMENTS, SUCH AS THE BLADES OF SECATEUR-TYPE CUTTING TOOLS, AND A CUTTING TOOL COMPRISING SAME

(71) Applicant: Daniel Delmas, Cahuzac Sur Vere (FR)

(72) Inventor: Daniel Delmas, Cahuzac Sur Vere (FR)

(73) Assignee: INFACO SAS, CAHUZAC SUR VERE (FR)

(21) Appl. No.: 13/636,912

(22) PCT Filed: Mar. 24, 2011
(86) PCT No.: PCT/EP2011/054513

§ 371 Date: Nov. 15, 2012

(30) Foreign Application Priority Data
Mar. 24, 2010 (FR) 1001185

(51) Int. Cl. G05B 11/36; A01G 3/033

(52) U.S. Cl. 30/228; 318/647

(57) ABSTRACT

A device for controlling the positioning of two elements, one of which is stationary while the other is mobile and driven by a geared motor member, the position of the mobile element being controlled by that of a trigger, includes: a circuit; a first stationary Hall effect sensor connected and, together with a magnet borne by the mobile element, providing a negative or zero clearance positioning of the two elements; and a second Hall effect sensor connected to the control circuit and, together with a magnet borne by the mobile element, providing the maximum clearance positioning of the two elements. The magnet is positioned such that its north-south axis is perpendicular to the trajectory of same and the first sensor is disposed in an area where the field vector of the magnet has a component perpendicular to the north-south axis, the sensitive face of the first sensor being parallel thereto.

### TECHNICAL FIELD

This invention belongs to the field of devices used for controlling the positioning of two elements moving in relation to one another, one of which is stationary and the other mobile and driven, in order to determine at each moment their respective positions and consequently to act on the drive means of the mobile element, this means being able to be a geared motor. More particularly, and not restrictively, this invention is applied to the positional control of the cutting blades of a tool, which can be of the electric portable type such as, for example, a vine-cutting secateur, and other cutting tools used in the agricultural or industrial field.

### STATE OF THE PRIOR ART

From the state of the art, various control devices are known both for movement of the cutting blades and of their relative positions in relation to one another.

Typically, electric portable secateurs of the type of those used for vine cutting, cutting-back and other agricultural work comprise a first blade or hook, installed in a stationary manner on the frame of the tool and a second blade, mobile in relation to the preceding one and between a closed position and an open position and vice versa. This open position can be at the choice of the user, a full open position or else an intermediate so-called semi-open position between the full open position and the closed position. Ordinarily, the mobile blade is equipped with an arc-shaped rack with which a drive pinion is meshed with the output shaft of an electric geared motor installed in the handle of the tool.

The known devices, for controlling the respective positions of the cutting blades, ordinarily consist of potentiometric sensors each equipped with a slide that is mechanically connected to the mobile blade. The value of the output voltage is representative of the angular position of the two blades in relation to each other. The drawback of this arrangement is that it uses sensors provided with mobile and stationary elements in contact with one another and consequently is subject to wear.

Secateurs are also known that comprise, opposite the path of a magnet carried by the rack of the mobile blade, a series of Hall effect sensors placed at regular intervals along an arc. The Hall effect sensors each deliver, when the magnet is nearby, a piece of information that is representative of the angular position of the mobile blade in relation to the stationary blade. The advantage of this arrangement resides in the fact that intermediate positions of the mobile blade can be identified and reported, which makes it possible to define semi-open positions. However, this solution, because of the use of several Hall effect sensors, is costly and does not make it possible to determine semi-open positions other than those indicated by said sensors.

Other electric secateurs are known in particular from EP 1 574 125 and from FR 2 935 868.

Besides the above-cited drawbacks, no secateur of the prior art is equipped with simple and inexpensive means that make it possible to define blade-crossing positions to compensate for the wear of the latter, and with means for identifying simply and automatically the type of blade mounted on the cutting tool.

### SUMMARY OF THE INVENTION

This invention therefore has as its object to solve the above-mentioned problems.

For this purpose, a device for controlling the positioning of two elements in relation to one another, for example the blades of a cutting tool of the secateur type, one of which is stationary and the other mobile and connected mechanically to a geared motor element so as to be driven by the latter along a preestablished path, the position of said mobile element being slaved to the position of a control element such as a trigger, is characterized essentially in that it comprises a circuit for controlling the geared motor element, a stationary first Hall effect sensor, connected to the control circuit, able to indicate with a permanent bar magnet carried by the mobile element a zero or negative gap position of the two elements, and a second Hall effect sensor, connected to the control circuit, able to indicate with a permanent bar magnet carried by the mobile element a maximum gap position of the two elements, in that the first magnet is positioned so that its north-south axis is perpendicular to its path, and in that the first sensor is placed in an area in which the magnetic field vector of this first magnet exhibits a component perpendicular to said north-south axis, the sensitive face of said first sensor being parallel to the north-south axis of the corresponding magnet.

This arrangement, involving a secateur, thus makes it possible in closed position of the blades to define their degree of crossing by adjusting the value of their negative gap.

According to another characteristic of the invention, the first Hall effect sensor is able to provide two pieces of position information, namely abscissa and ordinate, of the corresponding magnet, in a Cartesian reference that is stationary in relation to said sensor, and the latter incorporates two Hall effect cells forming an angle between them, the sensitive surfaces of said cells being parallel to the north-south axis of the corresponding magnet.

Such an arrangement is designed to improve the precision of the positioning of the two stationary and mobile elements when the gap between the latter is slight.

According to another characteristic of the invention, the device comprises two magnets, one of which is functionally associated with the first Hall effect sensor and the other of which is functionally associated with the second Hall effect sensor, said magnets both being carried by the mobile element.

According to another characteristic of the invention, the two magnets are placed on different paths so that each Hall effect sensor cannot be influenced by the magnetic field of the magnet that is functionally associated with the other sensor.

According to another characteristic of the invention, the value of the minimum or negative gap between the mobile element and the stationary element is adjustable.

According to another characteristic of the invention, the control element carries a movable magnet opposite a Hall effect sensor occupying a stationary position in relation to the stationary element, said Hall effect sensor being connected to the control circuit and being able to measure continuously the magnetic field of the magnet and to send a signal that is representative of the instantaneous angular position of the control element, said control circuit being able to slave the position of the mobile element to the position of the control element.

According to another characteristic of the invention, the Hall effect sensor that is functionally associated with the magnet of the control element comprises two Hall effect cells forming an angle between them and is able to provide two pieces of distance information, such as abscissa and ordinate, of the position of the magnet in a Cartesian reference that is stationary in relation to said sensor.

According to another characteristic of the invention, the geared motor of the mobile element is current-controlled by the control circuit, and said circuit controls said geared motor by a chopper drive.

According to another characteristic of the invention, the control circuit sends a power supply signal from the electric geared motor and is adapted to perform a measurement of speed of the geared motor by processing this power supply signal.

According to another characteristic of the invention, the control circuit is able to incorporate the measurement of speed in relation to time to obtain a distance travelled and consequently the position of the mobile element in relation to the stationary element.

According to another characteristic of the invention, the control circuit is adapted to compare said instantaneous position with an instruction value that depends on the signal delivered by the Hall effect sensor associated with the control element.

The invention also has as its object an electric portable cutting tool comprising a stationary cutting blade and a mobile cutting blade actuated by an electric geared motor from the action on a trigger. This cutting tool is essentially characterized in that it comprises a positioning control device according to the invention.

According to another characteristic of the cutting tool, the mobile blade comprises a rack, and the magnets functionally associated with the first and second Hall effect sensors are carried by the rack.

According to another characteristic of the cutting tool, the control circuit is able to detect the type of blade by measuring the amplitude of the movement of the mobile blade between its full open position and its closed position during the first cutting, the angular gap between the two magnets signifying the type of blade used.

According to another characteristic of the cutting tool, a semi-open position, which is able to have its parameters set, of the cutting blades is foreseen, said position being defined during an initialization phase and being stored and compared by the control circuit to the calculated position of the mobile blade, said circuit controlling the stopping of the geared motor when the semi-open position is reached.

According to another characteristic of the invention, the control circuit is able to count separately the total number of cuttings performed and the cutting number that has led to a locking of the blades and statistically to process these two values to provide an item of information related to the degree of wear of the blades.

### SUMMARY DESCRIPTION OF THE FIGURES AND THE DRAWINGS

Other advantages, objects and characteristics of the invention will appear on reading the description of a preferred embodiment given by way of nonlimiting example while referring to the accompanying drawings in which:

FIG. 1 is a view of a diagram illustrating the general principle of a Hall effect cell,

FIG. 2 is a diagrammatic view of the device according to the invention associated with a cutting tool of the secateur type,

FIG. 3 shows the positioning of the first closing sensor in relation to the field lines of the corresponding magnet,

FIG. 4 is a detail view of the control circuit,

FIGS. 5 to 8 show various types of mobile blades.

### BEST MANNER OF PRODUCING THE INVENTION

In FIG. 1, a Hall effect cell 1 is shown diagrammatically. It can be seen that this cell, in parallelepipedic shape, exhibits two opposite end faces 10, two approximately opposite faces 11, and two opposite lateral faces 12. It can be seen that a current i passes longitudinally through this cell 1, entering the cell through one of the end faces 10 and exiting the cell through the other end face 10. This cell is plunged into a magnetic induction field B and is oriented in relation to this field so that the field lines are secant to the main faces 11. Under these conditions, a difference in electric potential or Hall voltage u appears between the lateral faces 12.

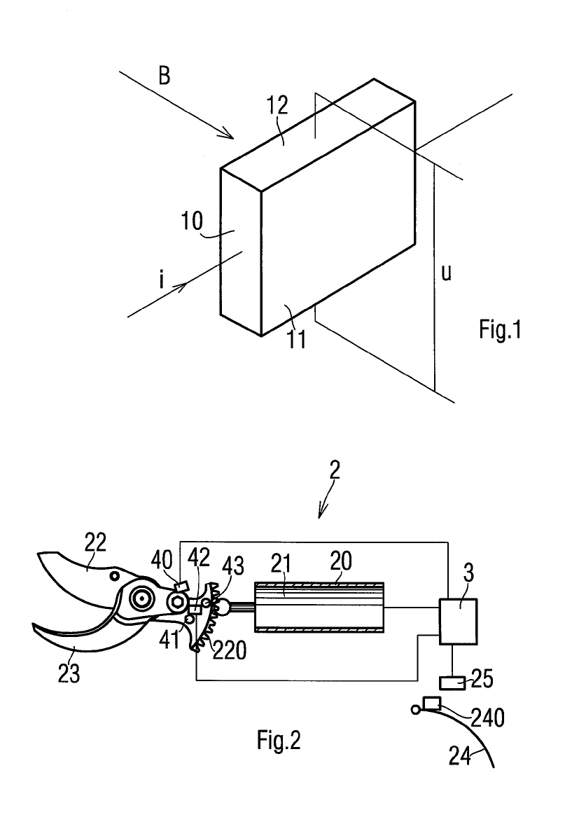

In FIG. 2, a cutting tool such as a secateur 2 for vine cutting, for example, is shown. This secateur comprises a frame to which is attached a hollow sleeve 20 in which is housed an electric geared motor 21, for example having direct current, for actuating a mobile blade 22 mounted so as to pivot on a pin that is solid with the chassis. A stationary blade 23 or hook is fastened to this chassis. This cutting tool 1 further exhibits a trigger 24, starting from whose actuation the geared motor 21 is activated by an electronic control circuit 3 to drive the mobile cutting blade 22 between its closed position and its open position and vice versa. The electric geared motor 21, and more generally all of the electric and electronic components of the cutting tool, are supplied with electric power by an external power source, not shown, consisting of, for example, a set of electric batteries mounted in a belt, or the like, carried by the user. This power source is connected to the cutting tool by a power cord.

Typically, the mobile blade 22, opposed to its cutting area, is equipped with an arc-shaped rack 220 with which a toothed pinion is meshed with the output shaft of the electric geared motor 21 by a transmission of movement in the form of a reduction gear.

The trigger 24 is equipped with a permanent magnet 240, and the secateur is equipped with a Hall effect sensor 25 able to measure continuously the magnetic field of the magnet and to send a signal that is representative of the instantaneous angular position of the trigger 24. This sensor 25 is connected to the control circuit 3. The latter is able to slave the angular position of the mobile blade 22 to the angular position of the trigger 24. Advantageously, this Hall effect sensor 25 comprises two Hall effect cells forming an angle between them and is able to provide two pieces of distance information, such as abscissa and ordinate, of the position of the magnet 240 in a Cartesian reference that is stationary in relation to the Hall effect sensor. These two pieces of distance information are processed by the control circuit 3 to determine the angle that the trigger 24 forms in relation to an initial position and to act as a consequence on the geared motor 21 to position the mobile blade 22 in the corresponding angular position. Preferably, the control circuit 3 establishes a relationship between these two values that gives the value of the tangent of the angle that the trigger 24 forms in relation to its original position. Knowing this value, it is then easy to determine the corresponding angular value.

Advantageously, the geared motor 21 is current-controlled by the control circuit 3, and the latter controls said geared motor 21 by a chopper drive 30. This control circuit sends a signal for supplying the electric geared motor 21 and is adapted to make a speed measurement of the rotor of the geared motor and consequently of the mobile blade, by processing this power supply signal. Moreover, this control circuit 3 is adapted to incorporate this measurement in relation to time so as to obtain a distance travelled and consequently the angular position of the mobile blade 22 in relation to the stationary blade. It is thus possible by this means to slave the position of the mobile blade 22 to the position of the trigger 24.

In practice, the control circuit 3 as well as the chopper 30 comprises a microcontroller 31, an analog-to-digital converter 32 and storage units not shown. The microcontroller 31 controls the electric geared motor 21 with current through a control drive of the chopper circuit 30 as a function of the signal that it receives from the Hall effect sensor 25 associated with the trigger 24.

Advantageously, the microcontroller 31 performs a measurement of speed of the rotor of the geared motor 21 by processing of the power supply signal of the geared motor 21, this speed measurement being performed during intervals of time where the current is zero, in the chopping periods, by measuring the back electromotive force produced by the geared motor. The value of this back electromotive force is representative of the angular speed of rotation of the rotor of the geared motor 21. In light of this measurement, a voltage divider bridge is connected, at the input to the geared motor, and at the output to the analog-to-digital converter, this converter being connected to the microcontroller. In practice, this voltage divider is made of four resistors 33 to 36.

The microcontroller 31 is adapted to incorporate in time the speed measurement so as to determine the instantaneous position of the output shaft of the geared motor 21 and consequently the instantaneous angular position of the mobile cutting blade 22 in relation to the stationary blade 23 and is adapted to compare said position with the value of the measurement of the angular position of the trigger 24. As a function of the result of this comparison, the microcontroller 31 makes a correction of the proportional-integral-derivative type.

The calculation of the instantaneous position of the mobile blade 24 authorizes an operation of the cutting tool in semi-open mode of the torque blades. The semi-open position is an intermediate position between the full open position and the closed position. Thanks to this semi-open mode of operation, the amplitude of the movement of the mobile blade 22 is limited and suited to the work envisaged. Furthermore, this arrangement leads to a gain in time and to a limiting of power consumption. Advantageously, this position is able to have its parameters set by the user during an initialization phase and is stored in memories of the control circuit. The control circuit 3, by comparing the instantaneous position of the mobile blade (position calculated by incorporation over time of the speed of the mobile blade) to the stored semi-open position, will make it possible to control the stopping of the geared motor 21 when the stored position will be reached. Thus, the stopping of the mobile blade in semi-open position is obtained without a mechanical stop nor without a dedicated sensor.

It should be noted that when the trigger is in released position, the mobile blade, according to the operating mode selected for the cutting tool, is either in semi-open position or in full open position. It should also be noted that the semi-open position depends only on the selection of the user.

Preferably, a switch is provided that can be operated by the user to switch the secateur either into full open mode or into semi-open mode. This switch is connected to the control circuit 3.

The control circuit 3 comprises in addition a first Hall effect sensor 40 installed in a stationary way in relation to the frame of the secateur and in relation to the stationary blade 23, a first permanent bar magnet 41 associated functionally with the first Hall effect sensor 40, mounted on the mobile blade 22 and indicating together with said sensor a closed position, and a second Hall effect sensor 42 installed in a stationary way in relation to the frame of the secateur and in relation to the stationary blade 23. This second sensor is connected to the control circuit and is able to indicate, with a second permanent bar magnet 43 carried by the mobile blade 22, a maximum open position of the two blades.

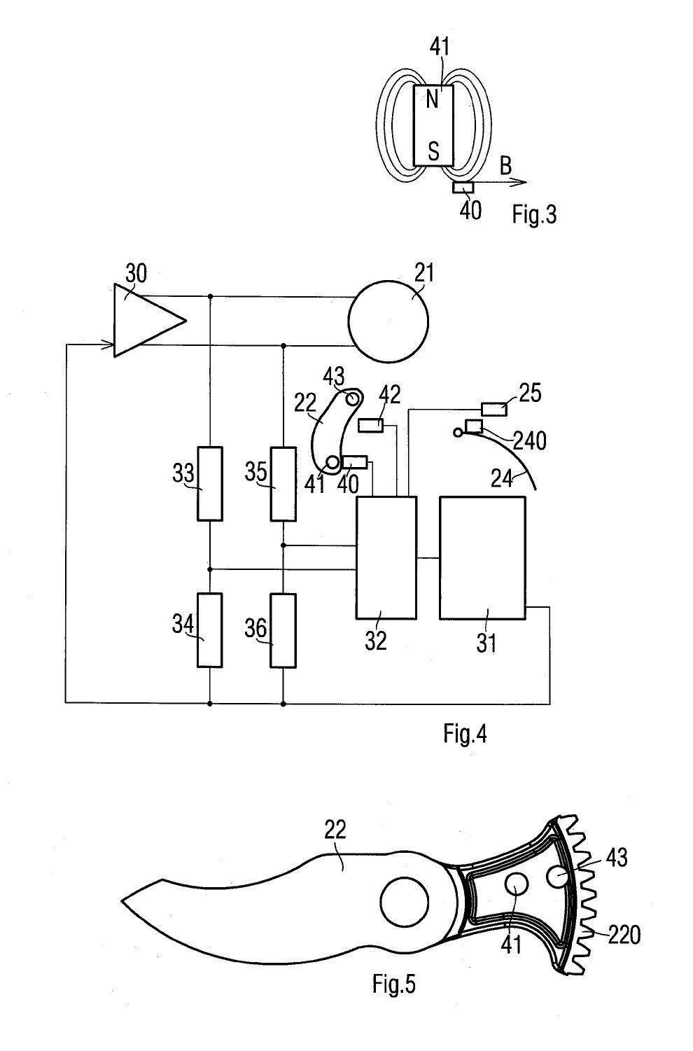

The first Hall effect sensor 40 is able to provide two pieces of position information, namely abscissa and ordinate, of the magnet 41, in a Cartesian reference that is stationary in relation to said sensor 40. This sensor 40 incorporates two Hall effect cells forming an angle between them, said cells by their main surfaces being parallel to the north-south axis of the corresponding magnet. Moreover, the first magnet 41 is positioned in such a way that its north-south axis is perpendicular to its path and the first sensor 40 is placed in an area in which the magnetic field vector of the first magnet 41 comprises a component perpendicular to said north-south axis (FIG. 3), the sensitive faces of this first sensor being parallel to the north-south axis of the corresponding magnet.

Because of these arrangements, the Hall effect sensor 40, when the magnet 41 is in its area of sensitivity, is able to deliver to the control circuit two pieces of information that are representative of the angular position of the magnet 41 in the above-mentioned Cartesian reference. Thus, it becomes possible, by the precise knowledge of this angular position, to adjust, in closed position of the blades, the value of the angular crossing of the latter. This angular crossing, according to which the wires of the two blades, in closed position, cross, makes it possible to compensate for the wear of the slicing of the latter. It should be noted that the regulating of this crossing is performed by the user, by the use of a suitable procedure, not described here. The crossing position is stored in a suitable memory of the control circuit.

Advantageously, the control circuit 3 establishes a relationship between the two values of abscissa and ordinate, which indirectly gives the value of the angular position of the magnet 41 in the Cartesian reference; more precisely, this relationship provides a tangent value.

It should be noted that the magnets 41 and 43 are placed on different paths from one another so that, in particular, each Hall effect sensor 40, 42 cannot be influenced by the magnetic field of the magnet associated with the other sensor. Also, the north-south axis of each of these magnets is parallel to the pivot pin of the blade 22.

Preferably, these magnets will be placed in suitable housings made in the rack 220 of the mobile blade 22.

The second Hall effect sensor 42 advantageously functions in on-off.

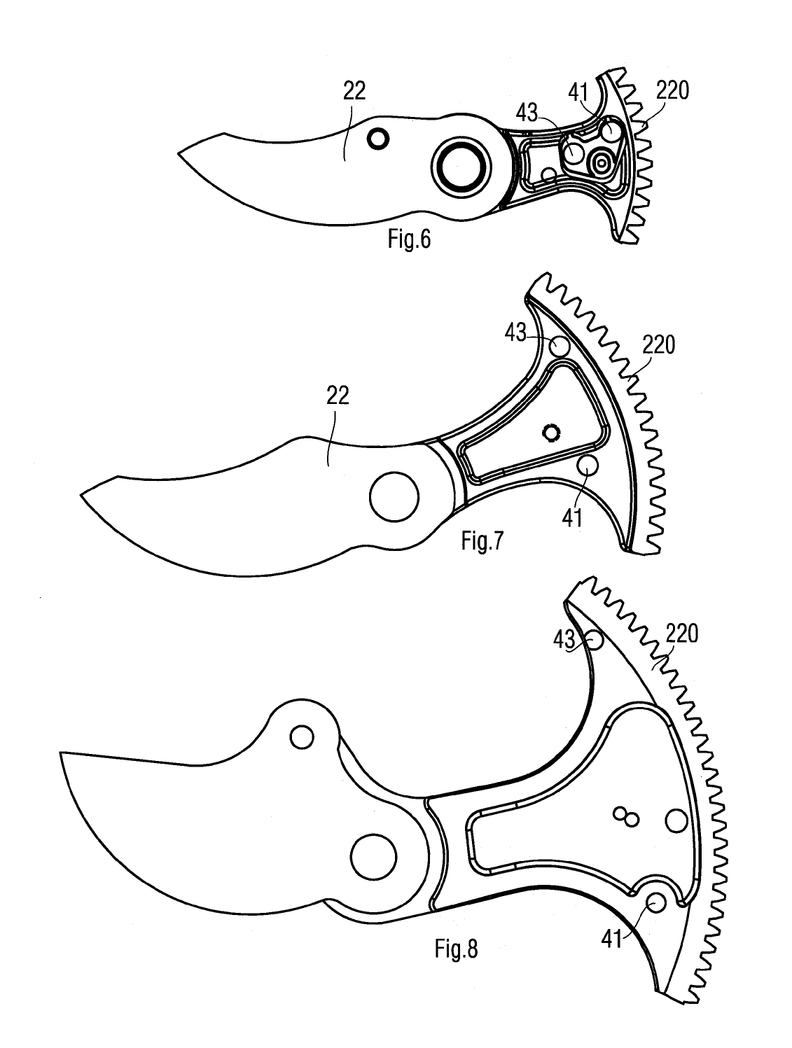

The secateur can receive several blade types corresponding to different kinds of jobs. These blades with their racks are shown in FIGS. 5 to 8.

It is necessary to be able to identify the type of blade installed on the secateur so that the control circuit 3 can particularly adapt the travel of the mobile blade 22 to the travel of the trigger 24. For this purpose, the blade type is identified by the angular gap between the magnets 41 and 43, this gap being different from one blade type to the next. The control circuit during the first cutting measures the distance travelled by the cutting blade between the full open and closed positions. This measurement of distance travelled thus makes it possible to identify the type of blade equipping the secateur.

The control circuit is able to count separately the total number of cuttings performed and the cutting number that has led to a locking of the blades. Thus, by statistical processing and comparison to pre-established values listed in memory, it will be possible to provide a piece of information related to the degree of wear of the blades knowing that a pronounced wear leads almost routinely to a locking These pieces of information will be stored in memory and processed by the control circuit 3.

Finally, it should be noted that the Hall effect sensors can comprise adapted magnetic circuits that make it possible to deflect the fields to be measured so as to place the sensitive cells in the same plane.

1. Device for controlling the positioning of two elements (22, 23) in relation to one another, for example the blades of a cutting tool of the secateur type, one (23) of which is stationary and the other (22) mobile and connected mechanically to a geared motor element (21) so as to be driven by the latter along a preestablished path, the position of said mobile element (22) being slaved to the position of a control element (24) such as a trigger, characterized in that it comprises a circuit (3) for controlling the geared motor element (21), a stationary first Hall effect sensor (40), connected to the control circuit (3), able to indicate with a permanent bar magnet (41), carried by the mobile element (22), a zero or negative gap position of the two elements (22, 23), and a second Hall effect sensor (42), connected to the control circuit (3), able to indicate with a permanent bar magnet carried by the mobile element (22) a maximum gap position of the two elements, in that the first magnet (41) is positioned so that its north-south axis is perpendicular to its path, and in that the first sensor (40) is placed in an area in which the magnetic field vector of this first magnet exhibits a component perpendicular to said north-south axis, the sensitive face of said first sensor (40) being parallel to the north-south axis of the corresponding magnet (41).

2. Control device according to claim 1, wherein the first Hall effect sensor (40) is able to provide two pieces of position information, namely abscissa and ordinate, of the corresponding magnet (41), in a Cartesian reference that is stationary in relation to said sensor, and wherein the latter incorporates two Hall effect cells forming an angle between them, the sensitive surfaces of said cells being parallel to the north-south axis of the corresponding magnet (41).

3. Control device according to claim 1, characterized by two magnets (41, 43), one (43) of which is functionally associated with the first Hall effect sensor (40) and the other (43) of which is functionally associated with the second Hall effect sensor (42), said magnets both being carried by the mobile element (22).

4. Control device according to claim 3, wherein the magnets (41) and (43) are placed on different paths so that each Hall effect sensor (40, 42) cannot be influenced by the magnetic field of the magnet that is functionally associated with the other sensor.

5. Control device according to claim 1, wherein the value of the minimum or negative gap between the mobile element (22) and the stationary element (23) is adjustable.

6. Control device according to claim 1, wherein the control element (24) carries a movable magnet (240) opposite a Hall effect sensor (25) occupying a stationary position in relation to the stationary element (23), said Hall effect sensor (25) being connected to the control circuit (3) and being able to measure continuously the magnetic field of the magnet (240) and to send a signal that is representative of the instantaneous angular position of the control element (24), said control circuit (3) being able to slave the position of the mobile element (22) to the position of the control element (24).

7. Control device according to claim 6, wherein the Hall effect sensor (25) comprises two Hall effect cells forming an angle between them and is able to provide two pieces of distance information, such as abscissa and ordinate, of the position of the magnet (240) in a Cartesian reference that is stationary in relation to said sensor (25).

8. Control device according to claim 6, wherein the geared motor (21) is current-controlled by the control circuit (3) and wherein said circuit drives said geared motor (21) by a chopper drive (30).

9. Control device according to claim 6, wherein the control circuit (3) sends a power supply signal from the electric geared motor (21) and is adapted to perform a measurement of speed of the geared motor (21) by processing this power supply signal.

10. Control device according to claim 9, wherein the control circuit (3) is able to incorporate the measurement of speed in relation to time to obtain a distance travelled and consequently the position of the mobile element (22) in relation to the stationary element (23).

11. Control device according to claim 10, wherein the control circuit (3) is adapted to compare said instantaneous position with an instruction value that depends on the signal delivered by the Hall effect sensor associated with the control element.

12. Electric portable cutting tool comprising a stationary cutting blade (23) and a mobile cutting blade (22) actuated by an electric geared motor (21) from the action on a trigger (24), wherein it comprises a control device according to claim 1.

13. Cutting tool according to claim 12, wherein the mobile blade (22) comprises a rack (220) and wherein the magnets (41, 43) are carried by the rack.

14. Cutting tool according to claim 12, wherein the control circuit (3) is able to detect the type of blade by measuring the amplitude of the movement of the mobile blade between its full open position and its closed position during the first cutting, the angular gap between the two magnets (41, 43) signifying the type of blade used.

15. Cutting tool according to claim 12, characterized by a semi-open position of blade (22), which is able to have its parameters set, said position being defined during an initialization phase and being stored and compared by the control circuit (3) to the calculated position of the mobile blade (22), said circuit (3) controlling the stopping of the geared motor (21) when the semi-open position is reached.

16. Cutting tool according to claim 12, wherein the control circuit (3) is able to count separately the total number of cuttings performed and the cutting number that has led to a locking of the blades and statistically to process these two values to provide an item of information related to the degree of wear of the blades.

17. Control device according to claim 2, characterized by two magnets (41, 43), one (43) of which is functionally associated with the first Hall effect sensor (40) and the other (43) of which is functionally associated with the second Hall effect sensor (42), said magnets both being carried by the mobile element (22).

18. Control device according to claim 7, wherein the geared motor (21) is current-controlled by the control circuit (3) and wherein said circuit drives said geared motor (21) by a chopper drive (30).
